(19) United States
(12) Patent Application Publication
(10) Pub. No.: US 2009/0205793 A1
(43) Pub. Date: Aug. 20, 2009

(54) WINDOW COVERINGS STRING COILER

(76) Inventor: Li-Ming CHENG, Kaohsiung City (TW)

Correspondence Address: Ching-Ling Huang, 5597 NW 127th Ter, Portland, OR, 97229, US

(21) Appl. No.: 12/426,455

(22) Filed: Apr. 20, 2009

Related U.S. Application Data
(63) Continuation-in-part of application No. 11/356,035, filed on Feb. 17, 2006, now abandoned.

(51) Int. Cl. E06B 9/00

(52) U.S. Cl. 160/405

(57) ABSTRACT

A window coverings string coiler includes a hollow casing, two brake wheel sets, a string winding wheel set, two resilient plates, a synchronous control member and a control set. The string winding wheel set has a first string winding wheel and a second string winding wheel that are hinged on the casing and coupled with a first gear and a second gear. The two brake wheel sets press the first and second string winding wheels. The synchronous control member is coupled with the first and second gears to control synchronous rotation thereof. The control set controls scrolling or opening of a window coverings. Through the first and second gears coupled with the string winding wheel set and the synchronous control member which controls synchronous rotation of the first and second gears, the first and second string winding wheels can rotate at the same speed to coil or release pulling strings.

### CROSS-REFERENCE TO RELATED APPLICATION

This application is a continuation-in-part, and claims priority, of from U.S. patent application Ser. No. 11/356,035 filed on Feb. 17, 2006, entitled “WINDOW COVERINGS STRING COILER”.

### FIELD OF THE INVENTION

The present invention relates to a window coverings string coiler, and more particularly to a string coiler that can be installed on a lower rail of a window coverings to provide a convenient way for users to scroll the blind up or down.

### BACKGROUND OF THE INVENTION

At present, a general window coverings includes a set of an upper rail rest and a lower rail rest spaced from each other, and a blind vane installed between the upper and lower rail rests and controlled by a plurality of pulling strings for scrolling up and down the blind vane to achieve a sun shading effect and provide a decorative function by installing on a window or a door.

Referring to FIG. 1, a lower rail rest 21 of a general window coverings 20 usually has a string coiler 10 connected to a pulling string for users to scroll or open a blind vane 22 of the window coverings 20. As shown in FIGS. 2 and 3, the string coiler 10 comprises a hollow casing 11, a gear set 12, a string winding wheel set 13, two resilient plates 14, two resilient plates 14, a synchronous control member 15 and a control set 16. The string winding wheel set 13 has a first string winding wheel 131 and a second string winding wheel 132 that have the bottoms coupled respectively with a first gear 121 and a second gear 122, and are spaced from each other and pivotally coupled in the casing 11 to respectively connect pulling strings 23 and 24 of the window coverings 20. The two resilient plates 14 are wedged respectively in the inner sides of the first and second string winding wheels 131 and 132. The synchronous control member 15 bridges the first gear 121 and the second gear 122 and control them to rotate synchronously. The control set 16 comprises a latch member 161, a push rod 162, and a spring 163. Through the push rod 162 and the spring 163, the latch member 161 can press the pulling strings 23 and 24 and prevent them from moving or falling out, or release them for moving.

Referring to the foregoing figures and FIG. 3, if a user wants to extend the blind vane 22 of the window coverings 20 downwards, the user presses the push rod 162 to separate the latch member 161 from the pulling strings 23 and 24 so that they are movable, and then applies force downwards to open the blind vane 22 of the window coverings 20. During the process of opening the blind vane 22, the two resilient plates 14 held on the first and second string winding wheels 131 and 132 are elastically retracted. After the blind vane 22 is opened, the push rod 162 can be released. The resilient restoring action of the spring 163 makes the latch member 161 to press and prevent the pulling strings 23 and 24 from moving again. On the other hand, if the user wants to scroll the blind vane 22 of the window coverings 20 upwards, the user presses the push rod 162 similarly, the latch member 161 is separated from the pulling strings 23 and 24, and the two elastically retracted resilient plates 14 drive the first and second string winding wheels 131 and 132 through the resilient restoring action to respectively coil the pulling strings 23 and 24. When the blind vane 22 reaches an expected height, the push rod 162 is released, the latch member 161 presses and prevents the pulling strings 23 and 24 from moving again. Thus coiling of the blind vane 22 can be accomplished.

However, the aforesaid string coiler 10 does not provide synchronous rotation control of the first and second string winding wheels 131 and 132. The first and second string winding wheels 131 and 132 could have different rotation speeds during the process of respectively scrolling or releasing the pulling strings 23 and 24, and thus result in inconsistent positions on two sides of the blind vane 22 during upward scrolling or downward opening. The decorative effect of the window coverings 20 also is affected adversely. The window coverings 20 also is easily damaged after being scrolled or opened through the string coiler 10 for a period of time.

### SUMMARY OF THE INVENTION

The primary objective of the present invention is to provide a window coverings string coiler to overcome the shortcoming of the prior art string coiler which does not provide synchronous rotation of the first and second string winding wheels and to facilitate scrolling and opening operation of the window coverings.

To achieve the foregoing objective, the present invention provides a technical feature that includes a window coverings string coiler comprising a hollow casing, two brake wheel sets, a string winding wheel set, two resilient plates, a synchronous control member and a control set. The hollow casing includes two corresponding protruding pillars, two ends each has an opening, and a through hole formed on one side. The two brake wheel sets are located respectively in a recess formed diagonally on a lower casing in a front and rear manner; each recess has a butting member and an elastic element. The butting member has a brake wheel hinged on one side and a slot in a middle section, and a trough on the other side to hold the elastic element. The brake wheel aims to press pulling strings of the string winding wheel set. The string winding wheel set includes a first string winding wheel and a second string winding wheel that are respectively coupled with a first gear and a second gear, and pivotally coupled on the two protruding pillars. The first and second string winding wheels also have respectively a containing groove formed inside. The two resilient plates are respectively held in the containing grooves. Each resilient plate has a first embedding end wedged in an inner side of the containing groove and a second embedding end anchored on the protruding pillar. The synchronous control member bridges the first and second gears and controls their synchronous rotation. The control set includes a latch member, a push rod and a spring. The latch member is located in the casing between the first and second string winding wheels, and has a latch portion extended respectively from two sides corresponding to the first and second string winding wheels. The push rod passes through the through hole of the casing. The spring has one end coupled on the latch member and the other end pressing an inner side of the lower casing.

In the structural design of the aforesaid window coverings string coiler, the string coiler is installed on the lower rail of the window coverings for users to scroll or open the blind vane. During the process of scrolling or opening the blind vane, the first and second gears coupled on the first and second string winding wheels are controlled by the synchronous control member to rotate synchronously. Therefore, the rotation speeds of the first and second string winding wheels also can be synchronized during the process of coiling or releasing the pulling strings. As a result, tilting of the blind vane during scrolling or opening can be prevented, and the life span of the window coverings can be enhanced.

### BRIEF DESCRIPTION OF THE DRAWINGS

FIG. 1 is a schematic view of a prior art string coiler installed on a window coverings;

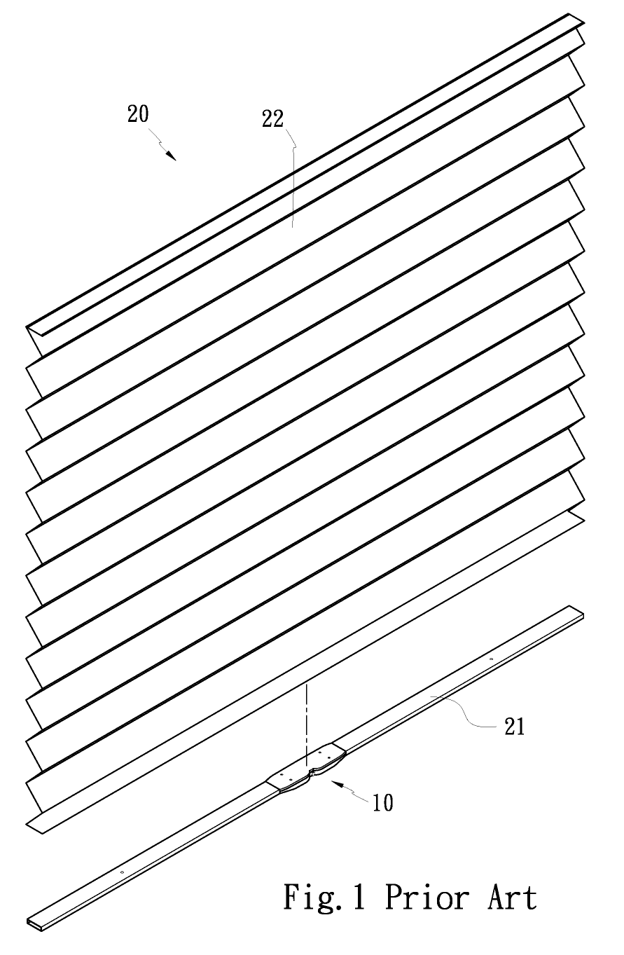

FIG. 2 is an exploded view of a prior art string coiler;

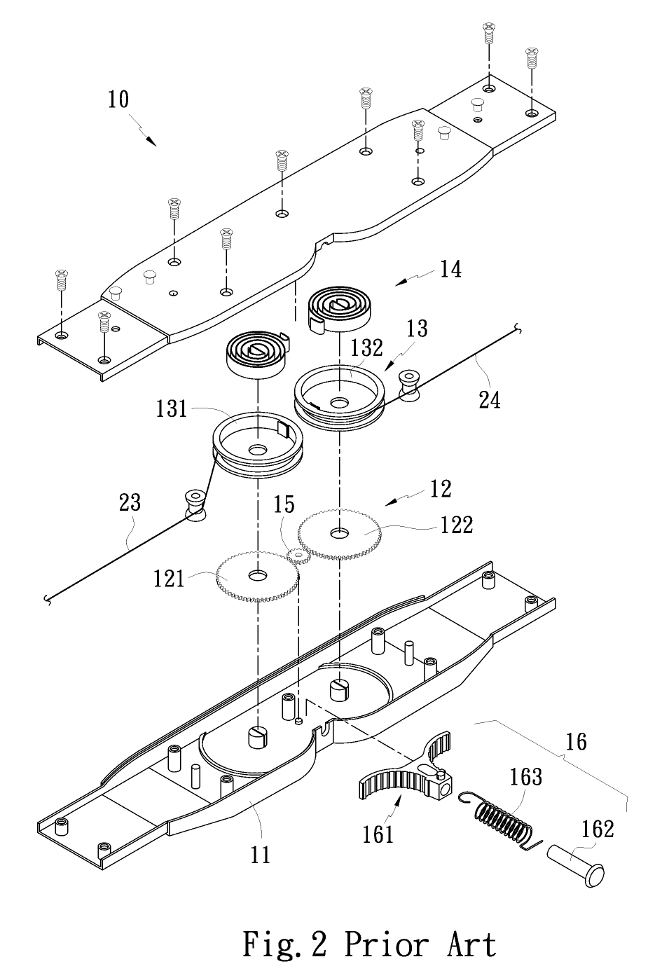

FIG. 3 is a top view of a prior art string coiler;

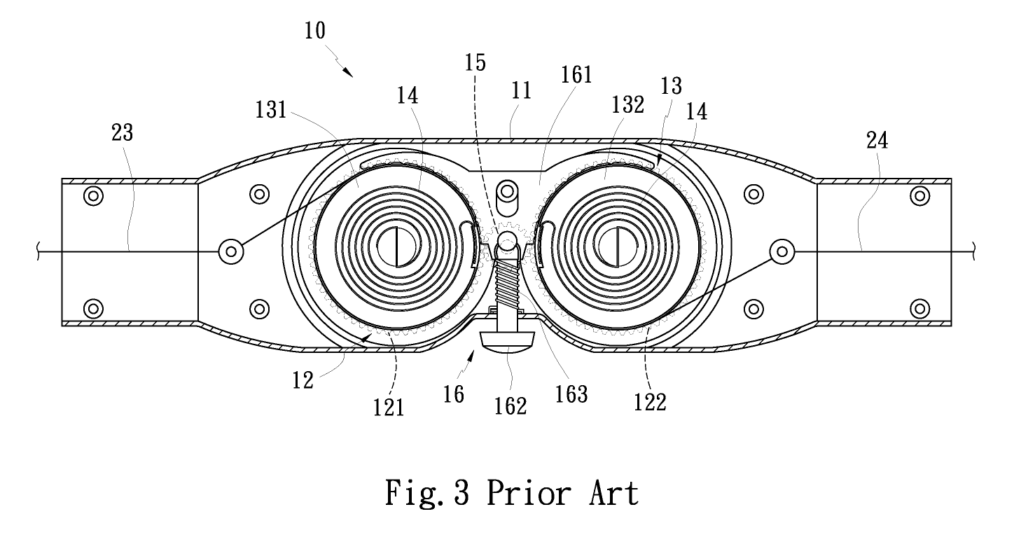

FIG. 4 is an exploded view of the string coiler of the invention;

FIG. 5 is a top view of the string coiler of the invention;

FIG. 6 is a schematic view of the invention showing two brake wheel sets and the control set pressing the pulling strings;

FIG. 7 is a schematic view of the invention showing the synchronous control member controlling the string winding wheel set in a synchronous rotation condition; and

FIG. 8 is a schematic view of the string coiler of the invention installed on a window coverings.

### DETAILED DESCRIPTION OF THE PREFERRED EMBODIMENTS

The present invention will now be described in more detail hereinafter with reference to the accompanying drawings as follows:

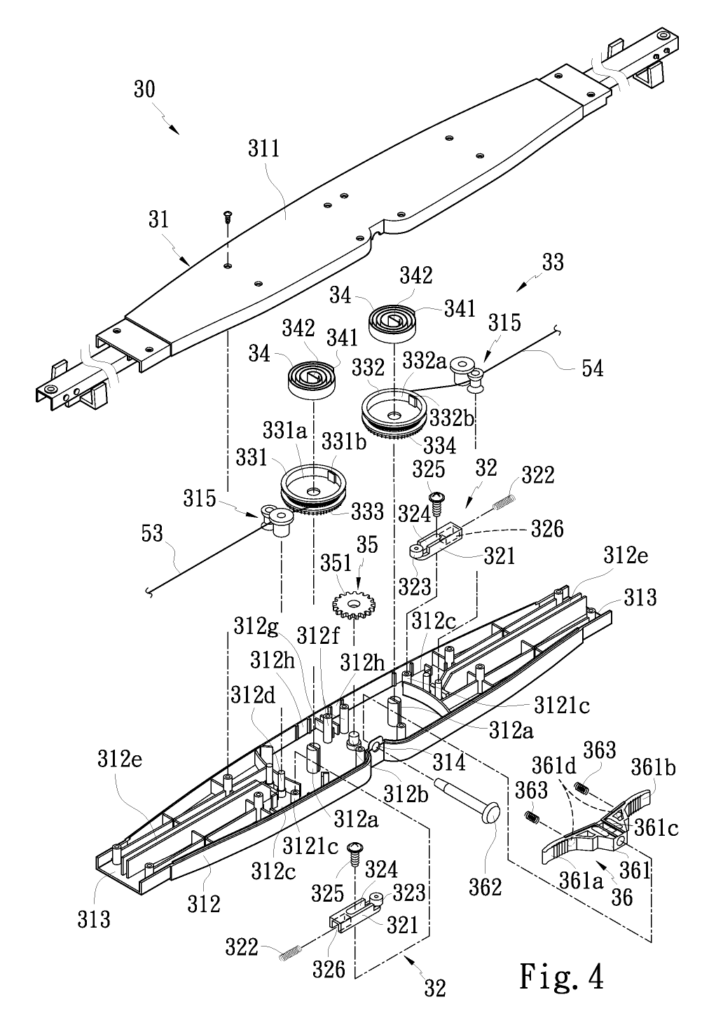

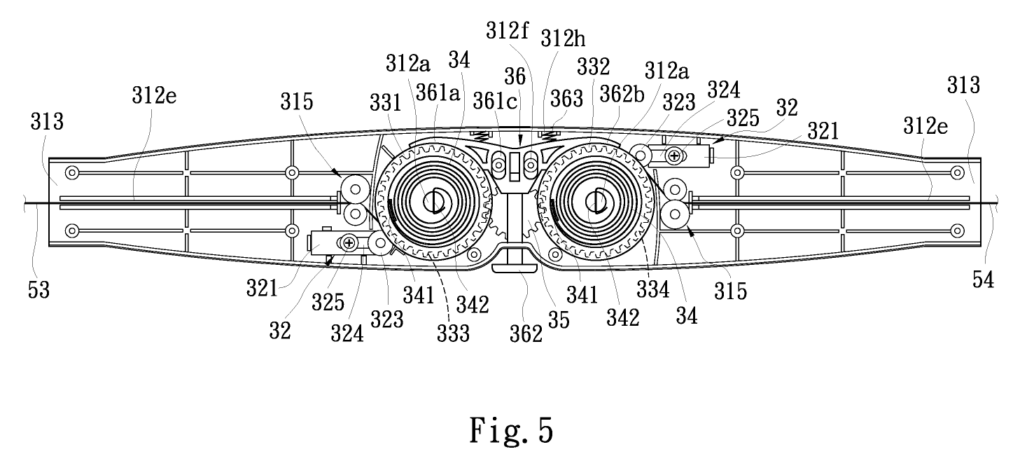

Referring to FIGS. 4 and 5, the window coverings string coiler 30 of the invention comprises a hollow casing 31, two brake wheel sets 32, a string winding wheel set 33, two resilient plates 34, a synchronous control member 35 and a control set 36.

The casing 31 comprises an upper casing 311 and a lower casing 312 engaged with each other in an up and down manner to form an opening 313 respectively at two ends. The lower casing 312 includes two corresponding protruding pillars 312a located on an inner side thereof, a pivot 312b between the two protruding pillar 312a, and recesses 312c formed diagonally in a front and rear manner with struts 3121c located inside to hold the brake wheel sets 32. The casing 31 further has posts 312d and threading slots 312e located in the center at two sides. Two guiding struts 312f and a bucking member 312g are formed at an upper end opposing the pivot 312b. The bucking member 312g has two sides with two corresponding anchor members 312h formed thereon. The casing 31 further has a through hole 314 formed on one side.

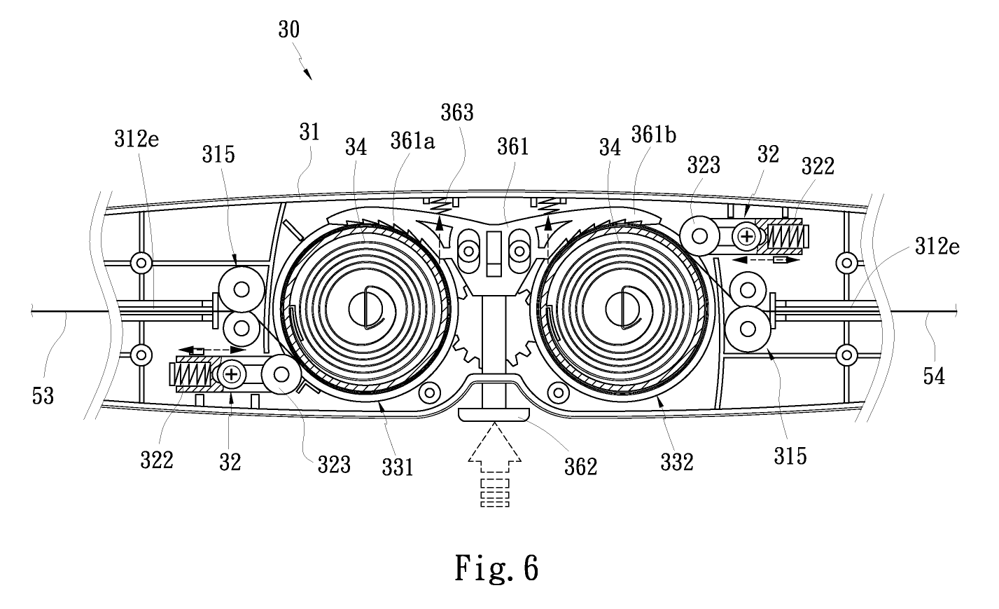

The two brake wheel sets 32 are respectively held in the recesses 312c; each has a butting member 321 and an elastic element 322. The butting member 321 has one side with a brake wheel 323 hinged thereon, a slot 324 formed in a middle section and passed through by the strut 3121c and fastened by a fastening element 325, and the other side with a trough 326 formed thereon to hold the elastic element 322. The brake wheel 323 thus positioned can press pulling strings 53 and 54 wound on the string winding wheel set 33 (referring to FIG. 6).

The string winding wheel set 33 includes a first string winding wheel 331 and a second string winding wheel 332 coupled respectively with a first gear 333 and a second gear 334, and are pivotally coupled on the two protruding pillars 312a. The first and second string winding wheels 331 and 332 have respectively a containing groove 331a and 332a on an inner side thereof. The containing grooves 331a and 332a have respectively an inner wall with a latch slot 331b and 332b formed thereon.

The two resilient plates 34 are held respectively in the containing grooves 331a and 332a of the first and second string winding wheels 331 and 332. Each resilient plate 34 has a first embedding end 341 wedged in the latch slot 331b and 332b, and a second embedding end 342 anchored on the protruding pillar 312a.

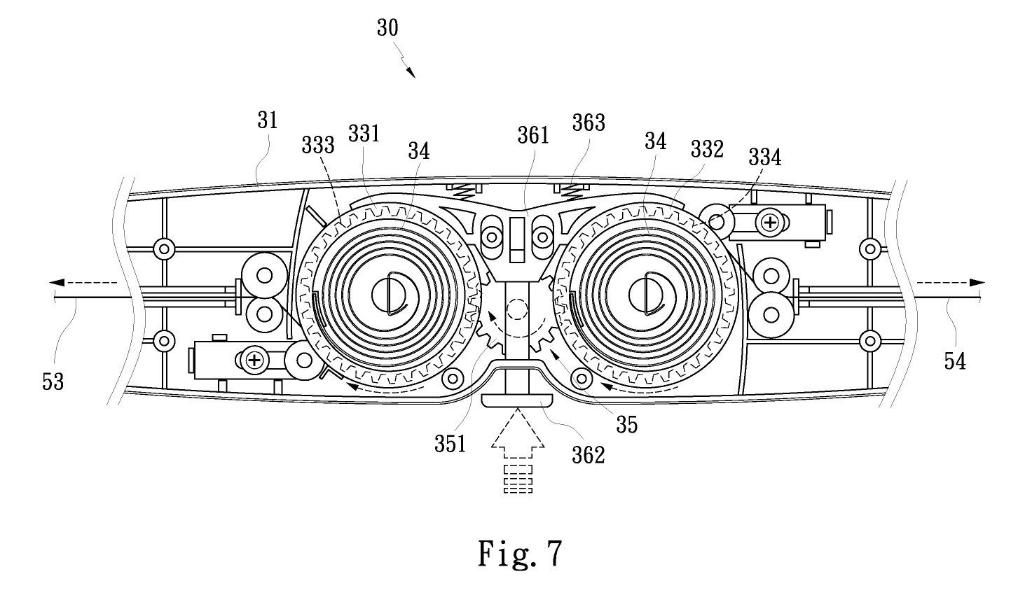

The synchronous control member 35 aims to bridge the first and second gears 333 and 334 to control their synchronous rotation. In an embodiment shown in FIG. 7, the synchronous control member 35 is a gear 351 engaged with the first and second gears 333 and 334 and pivotally coupled on the pivot 312b of the casing 31 to control the first and second gears 333 and 334 and the first and second string winding wheels 331 and 332 to rotate synchronously.

The control set 36 includes a latch member 361, a push rod 362, and a spring 363. The latch member 361 is located in the casing 31 between the first and second string winding wheels 331 and 332, and has latch portions 361a and 361b extended from two sides corresponding to the first and second string winding wheels 331 and 332. The push rod 362 runs through the through hole 314 of the casing 31. The latch member 361 also has a penetrating slot 361c run through by the two guiding struts 312f to confine movement of the latch member 361 in the lower casing 312. The latch member 361 further has a cavity 361d formed on an upper end surface to hold the spring 363. The spring 363 has one end held in the cavity 361d and the other end pressed the anchor member 312h of the lower casing 312.

Referring to FIG. 6, the casing 31 includes a roller set 315 located on one side of the first and second string winding wheels 331 and 332. When the first and second string winding wheels 331 and 332 are coupled with the pulling strings 53 and 54 of the window coverings 50, the roller set 315 directs the pulling strings 53 and 54 through the threading slot 312e without skewing.

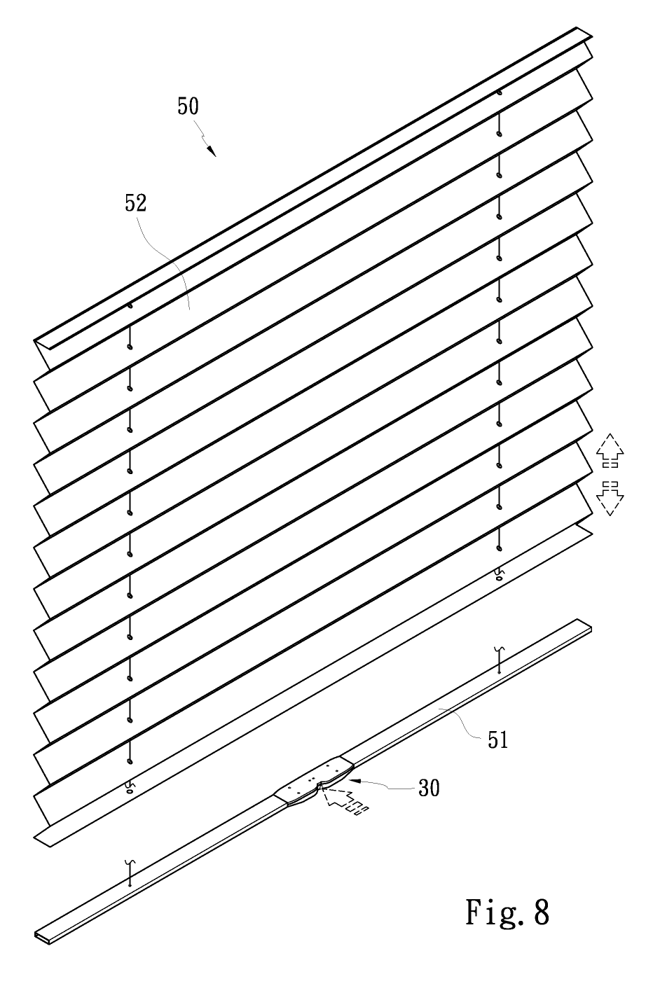

Also referring to FIGS. 6 through 8, the string coiler 30 of the invention is installed on a lower rail rest 51 of the window coverings 50. The first and second string winding wheels 331 and 332 are wound respectively by the pulling strings 53 and 54 of the window coverings 50. The pulling strings 53 and 54 are threaded through the two threading slots 312e of the lower casing 312 and the openings 313 at two ends of the casing 31 to the blind vane 52 of the window coverings 50. The latch member 361 is pressed by the spring 363 so that the latch portions 361a and 361b at two sides butt the pulling strings 53 and 54 from moving or release the pulling strings 53 and 54 for moving. Meanwhile, the brake wheels 323 of the two brake wheel sets 32 maintain pressing on the pulling strings 53 and 54 through the elastic element 322. Through the gear 351 of the synchronous control member 35, the first gear 333 and second gear 334, and the first string winding wheel 331 and second string winding wheel 332 can be controlled to rotate synchronously. Thus when a user wants to extend the blind vane 52 of the window coverings 50 downwards, he/she first presses the push rod 362 to separate the latch member 361 from the pulling strings 53 and 54, then applies downward force to lower and extend the blind vane 52. During the extending process, the two resilient plates 34 are retracted elastically. When extension of the blind vane 52 is finished, the push rod 362 can be released, and the spring 363 provides elastic restoring force to press the latch member 361 to butt the pulling strings 53 and 54 again to prevent them from moving. Similarly, when the user wants to scroll the blind vane 52 upwards, he/she also presses the push rod 362 to separate the latch member 361 from the pulling strings 53 and 54. The retracted resilient plates 34 provide elastic restoring force to drive the first and second string winding wheels 331 and 332 to coil the pulling strings 53 and 54 respectively. If the user wants to control the blind vane 52 at a selected height during scrolling, the push rod 362 can be released to allow the latch member 361 to press the pulling strings 53 and 54 again and prevent them from moving. Thus scrolling of the blind vane 52 can be accomplished as desired.

As a conclusion, the structural design of the string coiler 30 of the window coverings according to the present invention provides the following main features: when a user scrolls up or down the blind vane 52 of the window coverings 50 through the string coiler 30, the latch member 361 is pressed by the spring 363 so that the latch portions 361a and 361b at two sides butt the pulling strings 53 and 54 from moving or release them for moving. Meanwhile, the brake wheels 323 of the two brake wheel sets 32 maintain constantly pressing on the pulling strings 53 and 54 through the elastic element 322 so that the first and second string winding wheels 331 and 332 also can be driven to rotate synchronously and consistently through the coupled first gear 333 and second gear 334 and the synchronous control member 35. As a result, the pulling strings 53 and 54 can be wound upwards or extended downwards at the same speed to scroll or extend the blind vane 52 evenly without tilting. The decorative effect of the window coverings 50 improves and the life span of the window coverings 50 also can be enhanced.

What is claimed is:

1. A window coverings string coiler, comprising:
a hollow casing having two corresponding protruding pillars therein and two ends each having an opening, and two recesses formed diagonally in a front and rear manner, and a through hole formed on one side thereof;
two brake wheel sets which are located in the recesses and have respectively a butting member on one side pivotally coupled with a brake wheel and an elastic element located in the butting member;
a string winding wheel set which has a first string winding wheel and a second string winding wheel that have bottoms coupled respectively with a first gear and a second gear and are pivotally coupled on the two protruding pillars and have respectively a containing groove formed inside;
two resilient plates which are located respectively in the containing grooves of the first and second string winding wheels and have respectively a first embedding end anchored on an inner side of the containing groove and a second embedding end anchored on the protruding pillar;
a synchronous control member to couple with the first and second gears to control synchronous rotation thereof; and
a control set which has a latch member, a push rod and two springs; the latch member being located between the first and second string winding wheels in the casing and having latch portions extended from two sides corresponding to the first and second string winding wheels; the push rod running through the through hole of the casing; each spring having one end run through the latch member and the other end pressed an inner side of the casing.

2. The window coverings string coiler of claim 1, wherein the casing includes a pivot disposed between the two corresponding protruding pillars, and the synchronous control member is a gear engaged with the first and second gears and pivotally coupled on the pivot of the casing.

3. The window coverings string coiler of claim 1, wherein each recess has a strut located diagonally inside the casing in a front and rear manner, the butting member having a slot run through by the strut and a trough formed on the other side thereof.

4. The window coverings string coiler of claim 1, wherein the casing respectively has a roller set and a threading slot at one side corresponding to the first string winding wheel and the second string winding wheel.

5. The window coverings string coiler of claim 1, wherein the casing respectively has two guiding struts and a bucking member which has corresponding anchor members at two sides located between the first string winding wheel and the second string winding wheel, the latch member having a penetrating slot run through by the two guiding struts.

6. The window coverings string coiler of claim 1, wherein the casing includes an upper casing and a lower casing coupling together in an up and down manner.
